(19) United States
(12) Patent Application Publication
(10) Pub. No.: US 2026/0018361 A1
(43) Pub. Date: Jan. 15, 2026

(54) FUSE WITH INDENTED ENDCAPS

(71) Applicant: Littelfuse, Inc., Chicago, IL (US)

(72) Inventors: Mark Joseph Ilagan Lian, Batangas (PH); Fernando Isip Arce, JR., Paranaque Cite (PH); Francisco RIVERA De Guia, JR., Batangas (PH); Keon Mayson A. Brosas, Laguna (PH)

(73) Assignee: Littelfuse, Inc., Chicago, IL (US)

(21) Appl. No.: 18/772,481

(22) Filed: Jul. 15, 2024

(51) Int. Cl. H01H 85/165; H01H 85/055; H01H 85/18

(52) U.S. Cl. CPC H01H 85/165; H01H 85/055; H01H 85/18

(57) ABSTRACT

A fuse including a tubular fuse body, a fusible element extending through the fuse body, a first endcap disposed on a first longitudinal end of the fuse body in electrical communication with the fusible element, the first endcap having a first indentation defining a first indented surface extending into the fuse body, and a second endcap disposed on a second longitudinal end of the fuse body in electrical communication with the fusible element, the second endcap having a second indentation defining a second indented surface extending into the fuse body.

### FIELD OF THE DISCLOSURE

The present disclosure relates generally to the field of circuit protection devices and relates more particularly to a surface mount fuse having endcaps adapted to improve solder connections between the endcaps and a fusible element of the fuse.

### FIELD OF THE DISCLOSURE

Fuses are commonly used as overcurrent protection devices and are typically installed between a source of electrical power and a component in an electrical circuit that is to be protected. A cross-sectional view illustrating a conventional, prior art cartridge fuse 10 (hereinafter “the fuse 10”) is shown in FIG. 1. The fuse 10 includes a hollow, electrically insulating fuse body 12, and a fusible element 14 that extends diagonally through an interior of the fuse body 12 and is bent or wrapped around longitudinal end faces of the fuse body 12. Electrically conductive first and second endcaps 16, 18 cover the opposing longitudinal ends of the fuse body 12 and engage the fusible element 14, with quantities of solder (“solder domes”) 20, 22 being disposed on interior surfaces of the first and second endcaps to provide electrical connections with the fusible element 14. Upon the occurrence of a fault condition, such as an overcurrent condition wherein electrical current flowing through the fusible element 14 exceeds a predefined threshold, the fusible element 14 melts or otherwise separates to interrupt the flow of electrical current through the fuse 10, thus protecting connected electrical components.

A shortcoming associated with traditional cartridge fuses of the type described above is that the electrical connections between the first and second endcaps 16, 18 and the fusible element 14 can be unreliable. For example, if the solder domes 20, 22 are not properly formed (e.g., if the quantity of solder used is insufficient and/or if the solder domes are misshapen), electrical contact between the first and second endcaps 16, 18 and the fusible element 14 may not be robust enough to support a rated current of the fuse 10.

It is with respect to these and other considerations that the present improvements may be useful.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

A fuse in accordance with an embodiment of the present disclosure may include a tubular fuse body, a fusible element extending through the fuse body, a first endcap disposed on a first longitudinal end of the fuse body in electrical communication with the fusible element, the first endcap having a first indentation defining a first indented surface extending into the fuse body, and a second endcap disposed on a second longitudinal end of the fuse body in electrical communication with the fusible element, the second endcap having a second indentation defining a second indented surface extending into the fuse body.

A fuse in accordance with another embodiment of the present disclosure may include a tubular fuse body having first and second end faces at opposing first and second longitudinal ends thereof, a fusible element extending through the fuse body, the fusible element having a first end bent over the first end face and a second end bent over the second end face, a first endcap disposed on the first longitudinal end of the fuse body in electrical communication with the fusible element, the first endcap defining a first indented surface extending into the fuse body, and a second endcap disposed on the second longitudinal end of the fuse body, the second endcap defining a second indented surface extending into the fuse body.

A fuse in accordance with another embodiment of the present disclosure may include a tubular fuse body, a first endcap disposed on a first longitudinal end of the fuse body, a second endcap disposed on a second longitudinal end of the fuse body, a fusible element extending axially through the fuse body, the fusible element affixed at a first end to an interior surface of the first endcap and affixed at a first end to an interior surface of the second endcap, wherein the first endcap has a first indentation defining a first indented surface extending into the fuse body, the first indented surface having an annular shape and radially surrounding the first end of the fusible element, and wherein the second endcap has a second indentation defining a second indented surface extending into the fuse body, the second indented surface having an annular shape and radially surrounding the second end of the fusible element.

### BRIEF DESCRIPTION OF THE DRAWINGS

FIG. 1 is a cross-sectional view illustrating a fuse in accordance with the prior art;

FIG. 2 is a cross-sectional view illustrating a fuse in accordance with an embodiment of the present disclosure;

FIG. 3 is a cross-sectional view illustrating an end of a fuse in accordance with another embodiment of the present disclosure;

FIG. 4 is a cross-sectional view illustrating an end of a fuse in accordance with another embodiment of the present disclosure;

FIG. 5A is a cross-sectional view illustrating an end of a fuse in accordance with another embodiment of the present disclosure;

FIG. 5B is bottom view illustrating an end cap of the fuse shown in FIG. 5A.

### DETAILED DESCRIPTION

Embodiments of a fuse and a method for manufacturing the same in accordance with the present disclosure will now be described more fully with reference to the accompanying drawings, in which preferred embodiments of the present disclosure are presented. The fuse and the accompanying method of the present disclosure may, however, be embodied in many different forms and should not be construed as being limited to the embodiments set forth herein. Rather, these embodiments are provided so that this disclosure will be thorough and complete, and will fully convey the scope of the fuse and the accompanying method to those skilled in the art. In the drawings, like numbers refer to like elements throughout unless otherwise noted.

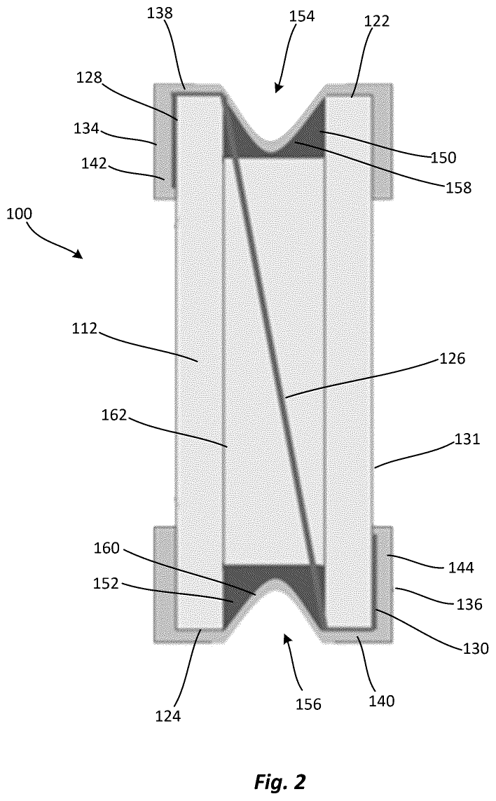

Referring to FIG. 2, a cross-sectional view of a fuse 100 (hereinafter “the fuse 100”) in accordance with an exemplary embodiment of the present disclosure is shown. For the sake of convenience and clarity, terms such as “top,” “bottom,” “above,” “below,” “lateral,” “longitudinal,” “radial,” etc. may be used herein to describe the relative placement and orientation of various components of the fuse 100, each with respect to the geometry and orientation of the fuse 100 as it appears in FIG. 2. Said terminology will include the words specifically mentioned, derivatives thereof, and words of similar import.

The fuse 100 may include an elongated, tubular fuse body formed of an electrically insulating and preferably heat resistant material, including, but not limited to, ceramic or glass. The fuse body 112 may have the shape of a square tube, but this is not critical. Alternative embodiments of the fuse 100 may have a fuse body 112 with the shape of a round tube, an oval tube, a triangular tube, etc.

The fuse 100 may include a fusible element 126 that extends diagonally through a hollow interior of the fuse body 112, from one lateral side of the fuse body 112 (e.g., the left side of the fuse body 112 as oriented in FIG. 2) to an opposite lateral side of the fuse body 112 (e.g., the right side of the fuse body 112 as oriented in FIG. 2). First and second ends 128, 130 of the fusible element 126 may be bent or wrapped over the first and second end faces 122, 124 of the fuse body 112 onto an exterior surface 131 of the fuse body 112. The fusible element 126 may be formed of an electrically conductive material, including, but not limited to, tin or copper, and may be configured to melt and separate upon the occurrence of a predetermined fault condition in the fuse 100, such as an overcurrent condition in which an amount of current exceeding a predefined, maximum current flows through the fusible element 126. The fusible element 126 may be any type of fusible element suitable for a desired application, including, but not limited to, a fuse wire, a corrugated strip, a fuse wire wound about an insulating core, etc.

The fuse 100 may further include electrically conductive first and second endcaps 134, 136 disposed on the first and second longitudinal ends of the fuse body 112, respectively, in electrical communication with the fusible element 126. The first and second endcaps 134, 136 may include respective first and second end walls 138, 140 disposed in flat abutment with, and oriented parallel to, the first and second end faces 122, 124 of the fuse body 112, respectively. The first and second endcaps 134, 136 may further include respective first and second side walls 142, 144 extending perpendicularly from the first and second end walls 138, 140, respectively, and laterally surrounding the first and second ends of the fuse body 112, respectively. The first end 128 of the fusible element 126 may be sandwiched between first endcap 134 and the fuse body 112, and the second end 130 of the fusible element 126 may be sandwiched between second endcap 136 and the fuse body 112. The first and second endcaps 134, 136 may be formed of an electrically conductive material, including, but not limited to, copper or one of its alloys, and may be plated with nickel or other conductive, corrosion resistant coatings. Thus, the first and second endcaps 134, 136 may facilitate electrical connection of the fuse 100 within a circuit. For example, the first and second endcaps 134, 136 can be soldered to respective terminals on a printed circuit board (not shown).

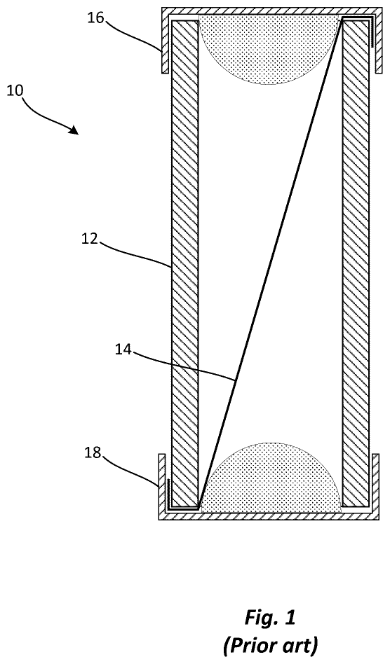

Still referring to FIG. 2, first and second solder fillets 150, 152 may be disposed on interior surfaces of the first and second end walls 138, 140 of the first and second endcaps 134, 136, respectively, to provide secure, robust electrical connections between the first and second endcaps 134, 136 and the fusible element 126. The first and second end walls 138, 140 of the first and second endcaps 134, 136 may include respective first and second indentations 154, 156 formed therein that provide the first and second endcaps 134, 136 with respective first and second embossed or domed interior surfaces 158, 160 (hereinafter “the first and second indented surfaces 158, 160”) extending into the longitudinal ends of the hollow interior of the fuse body 112. The first and second indented surfaces 158, 160 cause the first and second solder fillets 150, 152 to collect or pool between the first and second indented surfaces 158, 160 and an interior surface 162 of the fuse body 112, thus concentrating a majority of the first and second solder fillets 150, 152 in areas through which the first and second ends 128, 130 of the fusible element 126 pass. This increases the volume of solder connecting the first and second endcaps 134, 136 to the fusible element 126 relative to conventional fuses in which most of the solder is concentrated on a center of the endcaps, away from a fusible element (e.g., see FIG. 1), thereby providing a more robust electrical connection between the first and second endcaps 134, 136 and the fusible element 126 relative to conventional fuses.

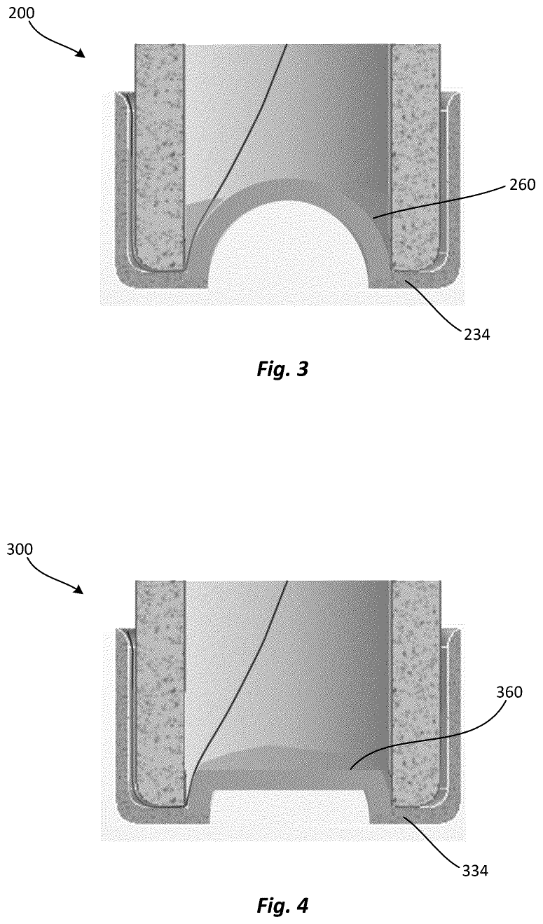

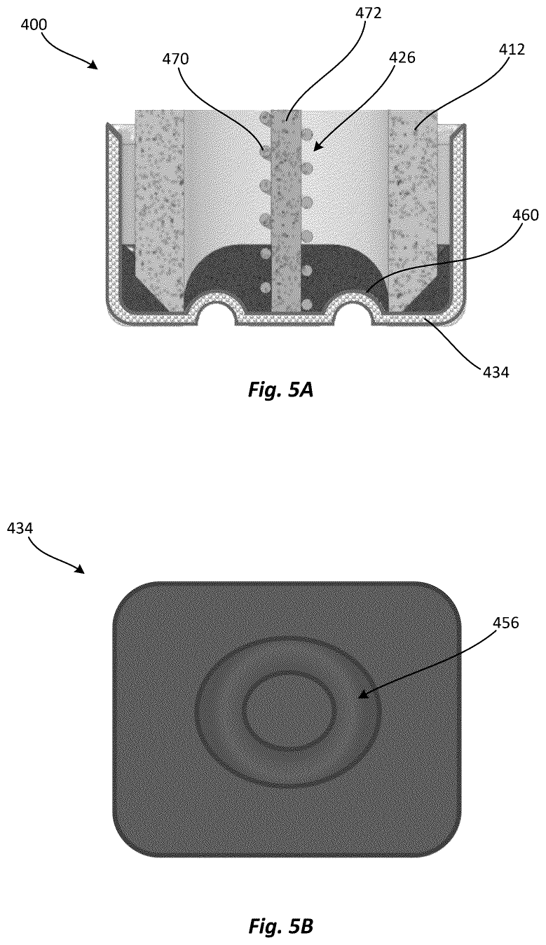

As depicted in FIG. 2, the first and second indented surfaces 158, 160 are generally V-shaped. This is not intended to be limiting, and various alternative embodiments of the fuse 100 are contemplated wherein the first and second indented surfaces 158, 160 may be provided with different shapes. For example, referring to FIG. 3, a cross-sectional view illustrating an end of another fuse 200 in accordance with an embodiment of the present disclosure is shown, wherein an endcap 234 of the fuse 200 has an indented surface 260 having a round or semi-circular shape. In another example shown in FIG. 4, a cross-sectional view illustrating an end of a fuse 300 in accordance with an embodiment of the present disclosure is provided, wherein an endcap 334 of the fuse 300 has an indented surface 360 having a plateau or flat emboss shape. In another example shown in FIG. 5A, a cross-sectional view illustrating an end of a fuse 400 in accordance with an embodiment of the present disclosure is provided, wherein the fuse 400 has a fusible element 426 formed of a fuse wire 470 wound about an insulating core 472 extending axially through a fuse body 412 (i.e., extending in a direction parallel to a longitudinal axis of the fuse body 412) and affixed to a center of an endcap 434. In this embodiment, the endcap 434 has an indented surface 460 having an annular shape (see also the bottom view of the endcap 434 shown in FIG. 5B, illustrating an annular indentation 456 corresponding to the annular indented surface 458 shown in FIG. 5A) radially surrounding the fusible element 426 that promotes the collection of solder around the centrally located fusible element 426 (i.e., in a trench formed between the fusible element 426 and the indented surface 460).

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

1. A fuse comprising:
a tubular fuse body;
a fusible element extending through the fuse body;
a first endcap disposed on a first longitudinal end of the fuse body in electrical communication with the fusible element, the first endcap having a first indentation defining a first indented surface extending into the fuse body; and
a second endcap disposed on a second longitudinal end of the fuse body in electrical communication with the fusible element, the second endcap having a second indentation defining a second indented surface extending into the fuse body.

2. The fuse of claim 1, wherein the fusible element extends diagonally through the fuse body with a first end of the fusible element bent over a first end face of the fuse body and with a second end of the fusible element bent over a second end face of the fuse body.

3. The fuse of claim 1, further comprising:
a first solder fillet disposed between the first indented surface and an interior surface of the fuse body, the first solder fillet facilitating an electrical connection between the first endcap and the fusible element; and
a second solder fillet disposed between the second indented surface and the interior surface of the fuse body, the second solder fillet facilitating an electrical connection between the second endcap and the fusible element.

4. The fuse of claim 1, wherein:
the first endcap comprises:
a first end wall disposed in flat abutment with, and oriented parallel to, a first end face of the fuse body; and
a first sidewall extending perpendicularly from the first end wall and surrounding the first longitudinal end of the fuse body;
the first indentation being formed in the first end wall; and
the second endcap comprises:
a second end wall disposed in flat abutment with, and oriented parallel to, a second end face of the fuse body; and
a second sidewall extending perpendicularly from the second end wall and surrounding the second longitudinal end of the fuse body;
the second indentation being formed in the second end wall.

5. The fuse of claim 1, wherein at least one of the first indented surface and the second indented surface is V-shaped.

6. The fuse of claim 1, wherein at least one of the first indented surface and the second indented surface is semi-circular.

7. The fuse of claim 1, wherein at least one of the first indented surface and the second indented surface has a plateau shape.

8. The fuse of claim 1, wherein the fusible element extends axially thru the fuse body and has a first end connected to an interior surface of the first endcap and a second end connected to an interior surface of the second endcap, wherein the first indented surface is annular and radially surrounds the first end of the fusible element, and wherein the second indented surface is annular and radially surrounds the second end of the fusible element.

9. The fuse of claim 1, wherein the fusible element comprises a fuse wire wound about an electrically insulating core.

10. A fuse comprising:
a tubular fuse body having first and second end faces at opposing first and second longitudinal ends thereof;
a fusible element extending through the fuse body, the fusible element having a first end bent over the first end face and a second end bent over the second end face;
a first endcap disposed on the first longitudinal end of the fuse body in electrical communication with the fusible element, the first endcap defining a first indented surface extending into the fuse body; and
a second endcap disposed on the second longitudinal end of the fuse body, the second endcap defining a second indented surface extending into the fuse body.

11. The fuse of claim 10, wherein the fusible element extends diagonally through the fuse body.

12. The fuse of claim 10, further comprising:
a first solder fillet disposed between the first indented surface and an interior surface of the fuse body, the first solder fillet facilitating an electrical connection between the first endcap and the fusible element; and
a second solder fillet disposed between the second indented surface and the interior surface of the fuse body, the second solder fillet facilitating an electrical connection between the second endcap and the fusible element.

13. The fuse of claim 10, wherein:
the first endcap comprises:
a first end wall disposed in flat abutment with, and oriented parallel to, a first end face of the fuse body; and
a first sidewall extending perpendicularly from the first end wall and surrounding the first longitudinal end of the fuse body;
the first indentation being formed in the first end wall; and
the second endcap comprises:
a second end wall disposed in flat abutment with, and oriented parallel to, a second end face of the fuse body; and
a second sidewall extending perpendicularly from the second end wall and surrounding the second longitudinal end of the fuse body;
the second indentation being formed in the second end wall.

14. The fuse of claim 10, wherein at least one of the first indented surface and the second indented surface is V-shaped.

15. The fuse of claim 10, wherein at least one of the first indented surface and the second indented surface is semi-circular.

16. The fuse of claim 10, wherein at least one of the first indented surface and the second indented surface has a plateau shape.

17. A fuse comprising:
a tubular fuse body;
a first endcap disposed on a first longitudinal end of the fuse body
a second endcap disposed on a second longitudinal end of the fuse body;
a fusible element extending axially through the fuse body, the fusible element affixed at a first end to an interior surface of the first endcap and affixed at a first end to an interior surface of the second endcap;
wherein the first endcap has a first indentation defining a first indented surface extending into the fuse body, the first indented surface having an annular shape and radially surrounding the first end of the fusible element; and
wherein the second endcap has a second indentation defining a second indented surface extending into the fuse body, the second indented surface having an annular shape and radially surrounding the second end of the fusible element.

18. The fuse of claim 17, further comprising:
a first solder fillet disposed between the first indented surface and the fusible element; and
a second solder fillet disposed between the second indented surface and the fusible element.

19. The fuse of claim 17, wherein:
the first endcap comprises:
a first end wall disposed in flat abutment with, and oriented parallel to, a first end face of the fuse body; and
a first sidewall extending perpendicularly from the first end wall and surrounding the first longitudinal end of the fuse body;
the first indentation being formed in the first end wall; and
the second endcap comprises:
a second end wall disposed in flat abutment with, and oriented parallel to, a second end face of the fuse body; and
a second sidewall extending perpendicularly from the second end wall and surrounding the second longitudinal end of the fuse body;
the second indentation being formed in the second end wall.

20. The fuse of claim 17, wherein the fusible element comprises a fuse wire wound about an electrically insulating core.
